(19) United States
(12) Patent Application Publication
(10) Pub. No.: US 2024/0067074 A1
(43) Pub. Date: Feb. 29, 2024

(54) AWNING-COUPLED PROTECTION COMPONENT FOR VEHICLES

(71) Applicant: Ikamper.Co., Ltd, Paju-si (KR)

(72) Inventor: Sung Ho BYUN, Paju-si (KR)

(73) Assignee: Ikamper.Co., Ltd, Paju-si (KR)

(21) Appl. No.: 18/455,910

(22) Filed: Aug. 25, 2023

(30) Foreign Application Priority Data
Aug. 26, 2022 (KR) 10-2022-0107378

(51) Int. Cl. B60P 3/34

(52) U.S. Cl. CPC B60P 3/343

(57) ABSTRACT

An awning-coupled protection component for vehicles, which can be coupled to an awning rail formed on a vehicle awning case installed on the upper part of a vehicle, designed to protect both the upper part of the vehicle and an awning from external objects such as tree branches during off-road driving and can be easily attached to various types of vehicle awnings and does not affect the use of the vehicle awning after installation.

### CROSS REFERENCE

This application claims the benefits of South Korean Application No. 10-2022-0107378, filed on Aug. 26, 2022, the disclosure of which is incorporated herein by reference in its entirety.

### BACKGROUND

With the increasing demand for recreational activities and camping, the demand for vehicle awnings (sunshades) that are coupled to vehicles is also on the rise. A vehicle awning is installed on the side of a vehicle's roof and provides outdoor shelter from sunlight and rain, among other purposes. The vehicle awning is integrated into a roof box or roof rail on the vehicle's roof and travels with the vehicle.

On the other hand, while a vehicle is moving rapidly, collisions can occur between natural elements such as tree branches and the vehicle's awning. Due to the high speed of the vehicle, even if the vehicle awning is integrated into a roof box, a concern exists that frequent collisions with external objects can result in not only scratches but also damage and destruction. Furthermore, when a driver visits forested areas to see natural landscapes, take breaks, or engage in camping activities, the vehicle's awning can be subject to impacts, damage, wear, scratches, and other issues caused by external objects. Thus, a concern exists that damage to the vehicle's awning due to external objects could occur regardless of the vehicle's driving speed, whether the vehicle is parked or in motion in densely wooded areas.

On the other hand, the conventional prior art lacks a configuration that can protect a vehicle awning while in motion. For instance, the prior art related to a vehicle awning roof box, as disclosed in Korean Registered Utility Model Publication No. 20-0435913, titled “Multipurpose Vehicle Awning Roof Box,” involves integrating an automotive awning into the awning roof box. When installing the prior art on a vehicle roof, as mentioned above, the awning roof box can remain vulnerable to damage from collisions with external objects.

Furthermore, in cases where a vehicle awning is coupled to the exterior roof of a vehicle without a separate awning storage case, similar to the prior art, an issue arises where the vehicle awning cannot be adequately protected from external forces.

In particular, vehicle awnings are primarily made of fabric materials and serve roles similar to awnings or tents. Therefore, an issue arises when caught on tree branches or similar objects, potentially leading to the awning being torn and rendering it unusable.

### SUMMARY

The present disclosure relates to an awning-coupled protection component for vehicles, more specifically, an awning-coupled protection component for vehicles coupled to an awning rail formed on a vehicle awning case installed on the upper part of a vehicle, protecting the upper part of the vehicle and the awning from external objects such as tree branches during off-road driving. It is also suitable for various forms of vehicle awnings and does not interfere with the use of the vehicle awning even after installation.

The present disclosure is to solve the above-described problems, to protect a vehicle awning installed on the vehicle ceiling from a situation in which an external object such as a tree branch may be caught or collided with a vehicle awning during off-road driving so that the vehicle awning is damaged. The purpose is to provide an awning-coupled protection component for vehicles which can prevent damage to the vehicle awning and further prevent damage to the vehicle.

Moreover, the awning-coupled protection component for vehicles can be coupled with various vehicle awning devices to effectively protect a vehicle awning. The rail coupling part can be adjusted according to the installation status and aims to provide the awning-coupled protection component for vehicles which can safeguard the front part according to the shape of the coupled vehicle awning.

Furthermore, the purpose is to allow users to easily adjust the length and/or installation height of the awning-coupled protection component for vehicles according to the coupling status of a vehicle and a vehicle awning.

Additionally, the purpose is to provide an awning-coupled protection component for vehicles that prevents oxidation caused by rainwater, possesses durability to minimize scratches, is lightweight, and can be coupled with vehicle awnings or roof rails without causing bending or deformation due to the load of the awning-coupled protection component for vehicles. Furthermore, it aims to offer a long-lasting awning-coupled protection component for vehicles suitable for extended use.

The problems that the present disclosure aims to solve are not limited to those mentioned above. Other undisclosed problems will be clearly understood by those skilled in the art from the descriptions provided below.

To solve the problems, the present disclosure, an awning-coupled protection component for vehicles coupled to a vehicle awning to protect an awning from an external force, including: a frame part being coupled to a vehicle awning; and a cover part being coupled to the frame part to protect the vehicle awning, wherein the frame part includes: a coupling frame being coupled to the vehicle awning and extends in one direction; a support frame supporting the coupling frame and the cover part; and a fixed frame being installed the rear side of the cover part to couple the coupling frame and the support frame to the cover part, and wherein, the cover part is configured to have a predetermined angle with respect to the direction in which the coupling frame extends and to be inclined with respect to the coupling frame.

One end of the coupling frame is connected to the fixed frame, while the other end is designed to be connected to the vehicle awning rail and has a rail coupling part with an awning insertion groove, and wherein the awning insertion groove of the rail coupling part extends in the same direction as the direction in which the coupling frame extends.

The pre-determined angle is defined as the acute angle formed between the coupling frame and the cover part.

The cover part is formed with the first cover and the second cover which have the same shape, while the second cover is coupled in a stacked manner in the front-to-back direction on the rear side of the first cover and the first cover slides along the second cover to extend the horizontal length of the cover part.

A horizontal slide slit extended along the sliding direction is formed at the upper and lower ends of the second cover, wherein the first cover includes a through hole passing through the first cover and a cover fixation component passing through the through hole, and wherein the cover fixation component moves along the horizontal slide slit to secure the first cover to the second cover.

The second cover includes a plurality of vertical slide slits extending perpendicularly between the horizontal slide slits.

A frame fixation component penetrating the cover part and the fixed frame is movable along the plurality of vertical slide slits, so that the position of the cover part relative to the frame part can be adjusted.

The frame part is configured with a first material, and the cover part is configured with a second material that is different from the first material, and wherein the first material has higher rigidity compared to the second material, while the second material is lighter than the first material.

Thus, the present disclosure holds the effect of protecting a vehicle awning installed on the vehicle roof from potential damage caused by external objects such as tree branches during off-road driving, preventing them from getting caught or colliding with the vehicle awning. Furthermore, it can prevent damage to the vehicle itself.

Furthermore, the present disclosure can be coupled with various vehicle awning devices, allowing for effective protection of the vehicle awning. It also enables adjustment of the installation position according to different vehicle awning devices and situations. Additionally, it possesses the effect of protecting the front part in accordance with the shape of the coupled vehicle awning.

Furthermore, it offers durability that prevents oxidation caused by rainwater and minimizes scratches. With its lightweight design, it prevents deformation due to the load of the awning-coupled protection component for vehicles when coupled with vehicle awnings or roof rails. Additionally, it provides the advantage of long-term usability.

The effects of the present disclosure are not limited to those mentioned above, and other effects not mentioned can be clearly understood by those skilled in the art from the descriptions provided below.

### BRIEF DESCRIPTION OF THE DRAWINGS

FIG. 1 illustrates an awning-coupled protection component for vehicles according to the present disclosure.

FIG. 2 illustrates a side view of an awning-coupled protection component for vehicles according to the present disclosure.

FIG. 3 illustrates a rear view of an awning-coupled protection component for vehicles according to the present disclosure.

FIG. 4a illustrates a perspective view of a different embodiment of the rail coupling part according to the present disclosure.

FIG. 4b illustrates a perspective view of a different embodiment of the rail coupling part according to the present disclosure.

FIG. 5 illustrates an example of the coupling between the rail coupling part and the awning rail according to the present disclosure.

FIG. 6 illustrates an example of the horizontal expansion of the cover part according to the present disclosure.

FIG. 7 illustrates an example of the installation of an awning-coupled protection component for vehicles on a vehicle according to the present disclosure.

### DETAILED DESCRIPTION

The present disclosure is susceptible to various modifications and can have multiple embodiments. In order to exemplify specific embodiments and provide detailed explanations, certain embodiments are illustrated in the drawings.

However, this is not intended to limit the present disclosure to specific embodiments, and should be understood to encompass all modifications, equivalents, or alternatives falling within the scope of the concepts and technology of the present disclosure. While explaining each drawing, similar reference numerals have been used for similar components.

When a component is mentioned to be “connected” or “joined” to another component, it should be understood that the other component may be directly connected or joined, but other components could also be in between. On the other hand, when a component is mentioned to be “directly connected” or “directly joined” to another component, it should be understood that no other components are in between the mentioned components.

The terminology used in this application is employed merely to describe specific embodiments and is not intended to limit the scope of the present disclosure. Unless singular expressions clearly mean differently in context, they include plural expressions. In this application, terms such as “include” or “have” are used to specify that the features, numbers, steps, operations, components, parts, or their combinations as disclosed in the specification are present, rather than to preclude the presence or possibility of one or more other features, numbers, steps, operations, components, parts, or their combinations.

Hereinafter, embodiments of the present disclosure are described with reference to the attached drawings. The same reference numerals in each drawing represent the same components. In describing the present disclosure, detailed descriptions of related known functions or configurations are omitted to avoid ambiguity in the essence of the present disclosure.

The present disclosure relates to an awning-coupled protection component for vehicles that is coupled to a rail formed on a vehicle awning rail installed on the upper part of a vehicle. The awning-coupled protection component for vehicles is designed to protect the upper part of the vehicle and the awning from external objects such as tree branches. It is also designed for easy installation on various forms of vehicle awnings and does not affect the use of the vehicle awning even after installation.

Before proceeding with the description, it should be noted that the examples provided in this specification regarding the installation of the protective component (1) according to the present disclosure on a vehicle awning rail (2) where a vehicle awning is integrated or installed are merely illustrative and not intended to limit the scope of the present disclosure. The vehicle awning rail (2) encompasses structures such as cases for storing vehicle awnings, roof boxes, or vehicle roof rails, and it should be understood that it can be coupled with the protective component (1).

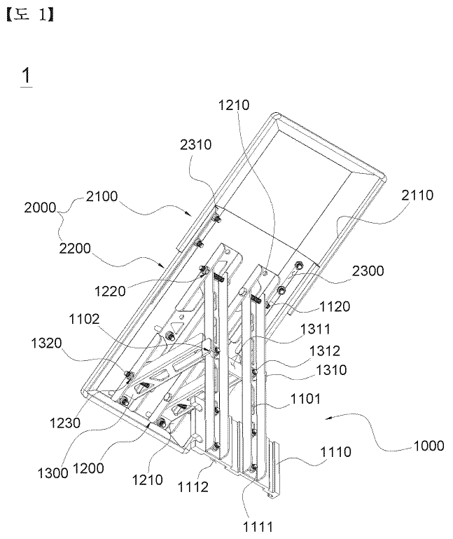

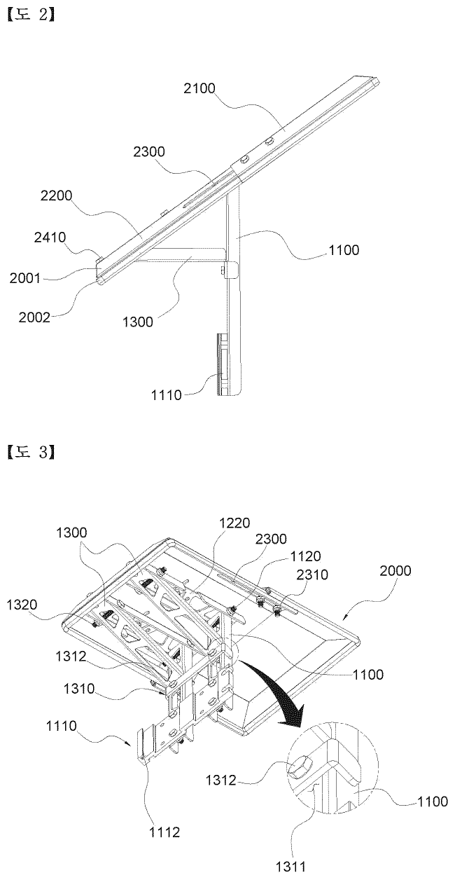

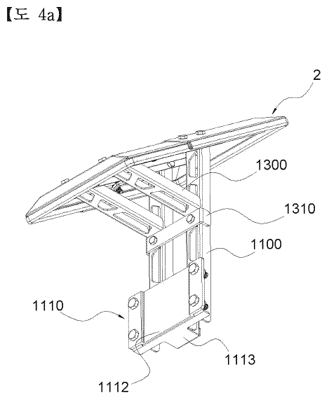

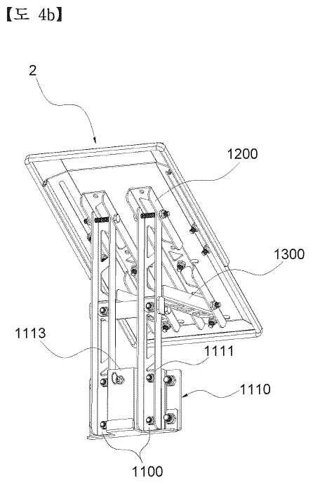

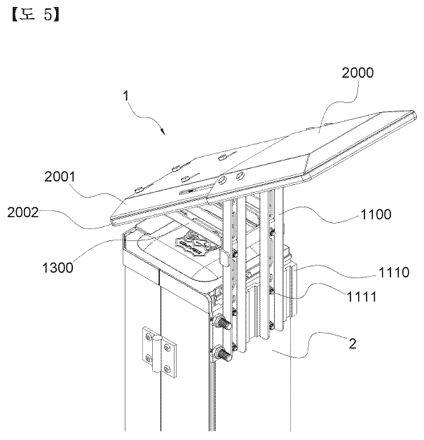

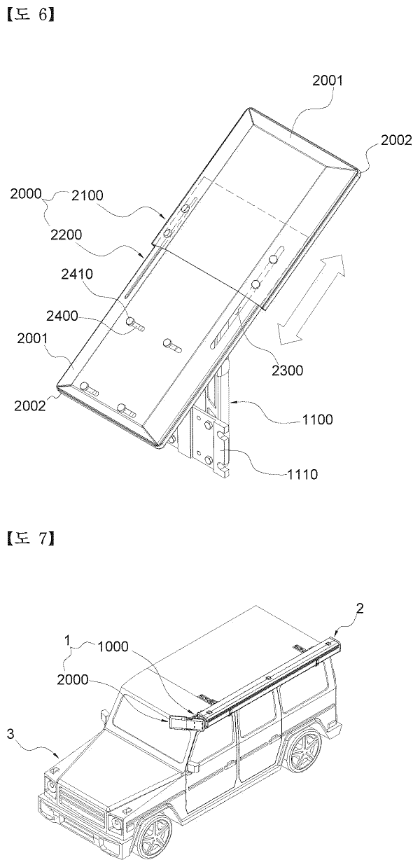

FIG. 1 illustrates an awning-coupled protection component for vehicles according to the present disclosure. FIG. 2 illustrates a side view of the awning-coupled protection component for vehicles according to the present disclosure. FIG. 3 illustrates a rear view of the awning-coupled protection component for vehicles according to the present disclosure. FIGS. 4a and 4b illustrate perspective views of different embodiments of the rail coupling part according to the present disclosure. FIG. 5 illustrates an example of the coupling between the rail coupling part and the awning rail according to the present disclosure. FIG. 6 illustrates an example of the horizontal expansion of the cover part according to the present disclosure. FIG. 7 illustrates an example of the installation of the awning-coupled protection component for vehicles on a vehicle according to the present disclosure.

First, the protective component (1) according to the present disclosure is composed of a frame part (1000) and a cover part (2000).

The frame part (1000) is coupled to the awning rail (2) to attach and install the protective component (1) on the upper part of the vehicle (3). One end of the frame part (1000) is coupled to the awning rail (2) and a cover part (2000) is provided at the other end, opposite to the one end, to protect the vehicle awning including the awning rail (2) from the outside.

The frame part (1000) includes a coupling frame (1100), a fixed frame (1200), and a support frame (1300) configured to be connected to each other. The frame part (1000) includes a coupling frame (1100) that couples with the awning rail (2), a support frame (1300) that supports the coupling frame (1100) and the cover part (2000), and a fixed frame (1200) that is installed on the rear of the cover part (2000) and couples the coupling frame (1100) and the support frame (1300) to the cover part (2000). The support frame (1300) is designed to prevent any change of the installation position of the cover part (2000) even when subjected to impacts on the cover part (2000), by being connected to the fixed frame (1200) on one end and to the coupling frame (1100) on the other end. The coupling frame (1100) is coupled to the awning rail (2) located on the outer ceiling of the vehicle and securely attach the protective component (1) to the awning rail (2) and the vehicle (3). On one end, it is coupled with the awning rail (2), and on the other end, it is coupled with the fixed frame (1200) located on the rear side of the cover part (2000).

These coupling frames (1100) are formed in pairs and have a tubular shape, with multiple lightening holes (1101) formed in the center. The lightening holes (1101) are formed through each of the coupling frames (1100) to ensure their lightweight and rigidity. This arrangement, with a pair of coupling frames (1100), enhances the coupling strength with the awning rail (2).

Meanwhile, the lightening holes (1101), as shown in the drawing, can be formed not only in the coupling frame (1100) but also in the fixed frame (1200) and the support frame (1300). This allows for the reduction of the weight of the protective component (1) by decreasing the weight of the frame part (1000).

On one end of the coupling frame (1100), the awning rail (2) is directly attached, and a rail coupling part (1110) that is bolt-coupled to the coupling frame (1100) is formed. This rail coupling part (1110) can have a plate-like shape and may also have an open configuration on the front and rear sides where the awning rail (2) is inserted.

The extension length of the coupling frame (1100) has an extended length within the range of 24 to 36 cm, with 30 cm being the most desirable, but this is not limited thereto.

Moreover, the thickness of the coupling frame (1100) has thin thickness within the range of 1.5 to 2.5 mm. In the embodiment, it is illustrated as 2 mm, but this is not limited thereto.

The rail coupling part (1110) is equipped on one end of the coupling frame (1100) to encase or adhere to the outer side of the awning rail (2).

The coupling fastening component (1111) can be equipped with the awning rail (2). It can also be equipped in a bonded state with an external plate that constitutes a vehicle awning by penetrating the rail coupling part (1110) to attach to the awning rail (2). The awning rail (2) can be inserted into an awning insertion groove (1112) that is recessedly formed on the inner side of the coupling fastening component (1111), allowing the rail coupling part (1110) to be mounted on the awning rail (2).

In this case, the protective component (1) can be inserted and mounted on the awning rail (2) in a sliding manner through the awning insertion groove (1112) formed in the rail coupling part (1110).

The rail coupling part (1110) is usually formed with aluminum in a plate shape through processes like CNC machining. Depending on the specifications or brand of the awning rail (2), different shapes of rail coupling parts (1110) can be manufactured or various specifications of rail coupling parts (1110) can be selectively replaced and attached allowing for coupling and securing to various forms of vehicle awnings. This is explained through FIGS. 4a and 4b.

First, the rail coupling part (1110) with a plate shape and awning insertion groove (1112) is illustrated in FIGS. 1 and 3, and this rail coupling part (1110) can be coupled to the awning rail (2) as shown in FIG. 5. On the other hand, if the outer shape of the awning rail (2) or the vehicle awning to be attached varies, the shape of the rail coupling part (1110) also needs to be adjusted accordingly. Therefore, in cases where protrusions are formed on one side of the awning rail (2) that needs to be coupled or when the rail is in a paired configuration, as shown in FIG. 3, the awning insertion grooves (1112) can be paired. However, for awning rails (2) without separate protrusions or rails, as shown in FIG. 4a, a rail coupling part (1110) with awning insertion grooves (1112) recessed to the same width as the coupling surface of the awning rail (2) can be applied. This allows the protective component (1) to be coupled and used with the awning rail (2) and the vehicle awning.

In this case, to improve the coupling force and fixing force between the rail coupling pat (1110) and the coupling frame (1100), a pair of coupling frames (1100) are spaced apart from each other on the rear side of the rail coupling part (1110) and a fitting protrusion corresponding to the space apart from each other (1113) can be protruded.

The protrusion (1113) is attached to the opposite side of the coupling frame (1100) from the surface that couples with the awning rail (2), around the rail coupling part (1110), and is secured through the coupling fastening component (1111). In this case, the spaced width between the paired coupling frames (1100) corresponds to the width of the protrusion (1113) that vertically protrudes from the other side. They fit into the spaced gap of the coupling frames (1100) and are fixed in place.

Therefore, through this mechanism, the rail coupling part (1110) can be more securely attached and fixed to the coupling frame (1100). Even if impacts are transmitted through the cover part (2000), the strong fixation provided by the rail coupling part (1110) prevents shocks from reaching the awning rail (2).

The rail coupling part (1110) can have various embodiments that can be adapted to the specifications of the awning rail (2) as mentioned above,

Furthermore, the rail coupling part (1110) can be moved or extended along the extended direction of the coupling frame (1100) to allow users to conveniently adjust the spacing between the installation position or cover part (2000) and the end of the awning rail (2), not necessarily limited to being only provided at the end of the coupling frame (1100) through the coupling fastening component (1111).

Additionally, the awning insertion groove (1112) into which the awning rail (2) is inserted inwardly can also be extended in the same direction as the extension of the coupling frame (1100) and rail coupling part (1110), centered around the rail coupling part (1110). This allows the rail coupling part (1110) to be tightly attached and secured to the awning rail (2). By having the inwardly inserted awning rail (2) fitted or interlocked in the awning insertion groove (1112), a coupling and fixation force can be enhanced between the awning rail (2) and the protective component (1).

The rail coupling part (1110) is extended with a lateral width of 16 cm, wider than the horizontal width between a pair of coupling frames (1100). In this case, although an example of a lateral width of 16 cm is mentioned for the rail coupling part (1110), it is not limited thereto. It is most desirable to manufacture it within a range of 13 to 20 cm.

Moreover, the recessed height of the awning insertion groove (1112) formed in the rail coupling part (1110) can be 0.4 cm, but this is not limited thereto. It is preferable that the awning rail (2) is drawn inward by being recessed within the range of 0.3 to 0.5 cm.

In addition, the rail coupling part (1110) has a thickness of 3 to 5 cm, but the thickness of both sides perpendicular to one surface is thicker than the thickness of the surface than the one surface on which the awning insertion groove (1112) is formed so that the awning rail (2) It is desirable to improve the binding force with.

On one end of the coupling frame (1100), a rail coupling part (1110) that couples with the awning rail (2) is formed, and on the other end of the coupling frame (1100) close to the cover part (2000), a through bolt (1120) that couples the fixed frame (1200) and the coupling frame (1100) is formed.

The through bolt (1120) penetrates in a direction perpendicular to the extension of the coupling frame (1100), and it passes through the fixed frame (1200) into which the other end of the coupling frame (1100) is inserted. This allows the coupling frame (1100) and the fixed frame (1200) to be integrally joined around the through bolt (1120) in a centered manner.

In this case, the through bolt (1120) has a bolt-like shape rather than a simple cylindrical shape, allowing the user to pivot the coupling frame (1100) at the desired angle. Subsequently, the other end of the coupling frame (1100) is fixed to the fixed frame (1200) through the through bolt (1120), enabling the coupling frame (1100) to support one side of the fixed frame (1200) and the cover part (2000).

In essence, by coupling the coupling frame (1100) to the awning rail (2) through the rail coupling part (1110), the impact transmitted through the fixed frame (1200) to the cover part (2000) is prevented from being transmitted to the awning rail (2). This prevents issues like bolt loosening due to frequent vibrations. Additionally, during off-road driving or collisions with external objects such as trees, the coupling frame (1100) supports and disperses the impact on the cover part (2000), while the rail coupling part (1110) securely couples with the awning rail (2) without transmitting the impact, ensuring a robust connection.

The installation angle of the coupling frame (1100) that is coupled to the fixed frame (1200) through the through bolt (1120) is preferably adjustable and fixed within the range of 45 to 65 degrees. When the installation angle exceeds 65 degrees, the supporting force of the cover part (2000) through the support frame (1300) is significantly reduced. Therefore, the installation angle should be set within the specified range to ensure proper support and installation.

The rail coupling part (1110) is made of aluminum and is anodized to prevent damage to the surface of the awning rail (2) or vehicle awning during the coupling process due to friction and other factors. This enhances corrosion resistance and wear resistance, preventing damage or deterioration from external environmental factors.

The fixed frame (1200) is formed with a pair of brackets on the rear side of the cover part (2000), being the opposite side of the front when the vehicle is moving, along the extension direction of the cover part (2000).

On one side of this fixed frame (1200), it is coupled with the end of the coupling frame (1100) through the through bolt (1120) as described above. On the other side, it can be coupled with the support frame (1300) and supported by the support frame (1300).

The fixed frame (1200) includes a frame insertion groove (1210) where the coupling frame (1100) and support frame (1300) are inserted inward, a through bolt insertion hole (1220) where the through bolt (1120) penetrates to couple the coupling frame (1100) and fixed frame (1200), and a fastening component through hole (1230) where a swivel bolt (1320) penetrates to couple the support frame (1300) and fixed frame (1200) as they are inserted inward.

In this case, the fastening component through hole (1230) is formed on one end, center, and the other end of the fixed frame (1200). Depending on the location where the protective component (1) is installed, users can align the fastening component through hole (1230) with a vertical slide slit (2400), and then secure the cover part (2000) and the fixed frame (1200) using the frame fixation component (2410). This allows the installation direction of the fixed frame (1200) to be established on either the rear side or the opposite side of the cover part (2000).

Furthermore, when the vertical slide slit (2400) and the frame fixation component (2410) are combined, the fixed frame (1200) and the cover part (2000) are coupled through the penetrating connection of the frame fixation component (2410). However, instead of tightly attaching the fixed frame (1200) and the rear side of the cover part (2000), by maintaining a certain distance, the frame fixation component (2410) can be easily loosened or tightened using tools from the outside.

The fixed frame (1200) is formed larger than the side width of the coupling frame (1100) and the support frame (1300). A frame insertion groove (1210) is formed where a portion of the inner end can be inserted, with the surface facing the coupling frame (1100) and the support frame (1300) being recessed inward.

The inner space of the frame insertion groove (1210) is connected with the inside of the through bolt insertion hole (1220) and the fastening component through hole (1230), and the coupling frame (1100) enters one side of the frame insertion groove (1210) is connected to one side of the fixed frame (1200) through the through bolt (1120) penetrated through the through bolt insertion hole (1220), and the support frame (1300) entered into the other side of the frame insertion groove (1210) The swivel bolt (1320) described later is coupled and fixed to the fixing frame (1200) through the fastening component through hole (1230).

The side that is closely attached to the fixed frame (1200) can also have the cover part (2000) and fixed frame (1200) joined together through methods such as welding. However, for the purpose of the cover part (2000) replacement or other reasons, the rear side of the fixed frame (1200) and the cover part (2000) can also be coupled using separate fastening components such as bolts.

The fixed frame (1200) has an extended length of 20 to 30 cm, and the position is most desirable to be at the center of the lower side of the cover part (2000). Furthermore, the desirable thickness for the fixed frame (1200) is the same thickness as the coupling frame (1100).

On the other hand, the awning rail (2) and the cover part (2000) can be connected to one side of the rear side of the cover part (2000) through the coupling frame (1100) coupled and fixed, and at the same time, when driving, the coupling frame (1100) can support the cover part (2000) facing the front side, but when only one side of the cover part (2000) is supported, the cover part (2000) is exposed to external forces such as wind or trees during driving. Therefore, a risk of bending in the other direction exists around the position where the coupling frame (1100) is supported.

Therefore, in the present disclosure, both sides are coupled with the coupling frame (1100) and the fixed frame (1200), and a support frame (1300) is provided to support the other side of the rear side of the cover part (2000), preventing deformation such as bending due to external forces on the cover part (2000) from the front and providing support to maintain its shape, similar to the coupling frame (1100).

The support frame (1300) is formed in pairs, each pair being capable of being coupled to the coupling frame (1100) and the fixed frame (1200). The support frame (1300) includes a coupling support part (1310) that is coupled and fixed to the outer side of the coupling frame (1100) and can slide along the length direction of the coupling frame (1100). On the other side, a swivel bolt (1320) is provided, which is coupled to the fixed frame (1200) and passes through both the fixed frame (1200) and the support frame (1300) to secure their connection.

First, the coupling support part (1310) is coupled to each end of the support frame (1300) that comprises a pair, forming an integral bracket shape. On one side that comes into contact with the coupling frame (1100), a pair of coupling frame insertion grooves (1311) are formed, which can be inserted into the outer sides of a pair of coupling frames (1100).

Therefore, as shown in FIG. 3, a pair of coupling frames (1100) is provided inside the coupling frame insertion grooves (1311), and are seated in close contact with the inner surface of the coupling frame insertion groove (1311), and the outer surface of the coupling support part (1310), that is, the other surface opposite to the one surface on which the coupling frame insertion groove (1311) is formed, the ends of the support frame (1300) are connected, so that one coupling support part (1310) moves along the longitudinal direction of the coupling frame (1100). In this case, the angle of the support frame (1300) supporting the cover part (2000) is changed. Through this coupling support part (1310), not only can a pair of support frames (1300) disperses the external forces it receives, but also the support frames (1300) can be easily adjusted in angle around the coupling support part (1310). This allows for varying the installation angle of the support frames (1300) based on the shape of the front of the automobile or the shape of the vehicle awning, including the awning rail (2). As a result, the installation configuration of the protective component (1) can be modified according to the shape of the vehicle awning. At this point, after positioning the support frames (1300) at a certain angle using the coupling support part (1310), the coupling support part (1310) can be fixed to the coupling frame (1100) through the coupling frame fixing bolt (1312). The swivel bolt (1320) penetrates vertically through the end of the support frame (1300) inserted into the frame insertion groove (1210) on the inner side, thereby coupling the support frame (1300) together with the fixed frame (1200) and preventing the support frame (1300) from deviating from its initial installation angle. This provides the advantage of securely fixing the support frame (1300) to the fixed frame (1200).

Therefore, during initial installation, the user can adjust the installation angle of the support frame (1300) around the swivel bolt (1320), and as the support frame (1300) rotates around the swivel bolt (1320), the coupling support part (1310) also slides along the outer side of the coupling frame (1100) in the length direction, allowing adjustment of the installation angle of the support frame (1300). Afterward, when the user installs the support frame (1300) at the desired angle, the user tightens and secures the swivel bolt (1320) using a nut or similar device. The support frame (1300) and coupling frame (1100) both support the fixed frame (1200) and the cover part (2000) by fixing the coupling support part (1310) through the coupling frame fixing bolt (1312), thereby preventing the cover part (2000) from shaking or the installation position from changing due to collisions with external objects.

In particular, in the case of the cover part (2000), during vehicle movement, external objects such as trees can collide from the outer front side, causing a backward force. In this situation, the support frame (1300) generates a rebound force, providing the advantage that the cover part (2000) can effectively protect the front and sides of the vehicle awning.

The support frame (1300) is preferably extended within a range of 10 to 20 cm, but shorter than the coupling frame (1100). In this case, the surface where the support frame (1300) contacts the fixed frame (1200) and the cover part (2000) is angled. Moreover, the thickness of the support frame (1300) is within the same range as that of the coupling frame (1100) and fixed frame (1200). The coupling support part (1310) should have a thickness of 2 to 4 cm, thicker than that of the support frame (1300), to be designed and manufactured in a way that securely fixes the support frame (1300) onto the coupling frame (1100).

Furthermore, the horizontally extended width of the coupling support part (1310) should have the same inner width as the outer horizontal width between a pair of support frames (1300), and the horizontal width of the coupling frame insertion groove (1311) is determined within the range of 75 to 115 cm, and the outer horizontal width, including the thickness, should extend within the range of 80 to 120 cm, making it desirable for design and manufacture. However, these values are not limited to the specified ranges. On the other hand, the coupling frame (1100), fixed frame (1200), and support frame (1300) can be securely coupled and fixed through bolt connections such as the through bolt (1120) and the coupling frame fixing bolt (1312). However, as mentioned above, each of these frames (1100), (1200), and (1300) is designed with an optimal installation angle to protect the vehicle awning and the vehicle (3) from the front. Therefore, in addition to coupling and fixing through separate bolt connections, these frames can also be manufactured into a single unit through welding.

The cover part (2000) is designed to have a predetermined angle with respect to the direction in which the coupling frame (1100) extends, forming a sloped surface. Thus, when the protective component (1) is connected to the vehicle awning through the awning rail (2), the upper surface of the awning can be covered by the cover part (200) of the protective component (1), physically blocking the potential transmission of impacts from the outside to at least the upper surface and further to the sides of the awning. The predetermined angle, as mentioned above, allows the support frame (1300) to have an adjustable installation angle around the coupling support part (1310) as a center, enabling the angle of the support frame (1300) to be changed accordingly. This is similar to being able to change the angle of the support frame (1300) to alter the installation configuration of the protective component (1) based on the shape of the vehicle's front end or the shape of the vehicle awning, including the awning rail (2). The predetermined angle refers to the angle at which the cover part is formed with an acute angle with respect to the coupling frame, in order to position the cover part to protect the awning from external impacts.

The frame part (1000) is made of steel material and galvanized then formed a clean film through powder coating. This not only streamlines the production process but also prevents difficulties in coupling between the coupling frame (1100), fixed frame (1200), and support frame (1300) due to unevenly coated surfaces. It ensures that these frames can be coupled and fixed in a closely bonded state.

However, the frame part (1000) is not limited to being made of steel material and can also be composed of functional polymers, aluminum, or other lightweight alloys for purposes of lightweighting, cost reduction, and disposability.

The cover part (2000) is configured on the front side of the frame part (1000), and it can protect the vehicle awning, including the frame part (1000), from external forces such as collisions with external objects received from the front side during vehicle movement.

The cover part (2000) can be made of a material different from that of the frame part (1000), and it can be formed with a relatively lightweight material compared to the frame part that supports without transmitting external forces through the awning rail (2). For example, the cover part (2000) can be primarily made of aluminum or lightweight functional plastics such as polycarbonate.

The cover part (2000) has a plate-like shape and is configured with a first cover (2100) and a second cover (2200) that are stacked on top of each other. The edges have a certain angle and are bent in the rearward direction to form a curved surface (2001), and along the edges of the cover part (2000), including the curved surface (2001), an anti-scratch member (2002) is formed to prevent scraping.

The curved surface (2001) can prevent the cover part (2000) with a plate-like shape from bending or generating noise caused by excessive resistance due to external forces (such as aerodynamic pressure) received from the front during vehicle movement. Additionally, the curved outer surfaces of the curved surfaces (2001), formed along the edges, can induce the dispersion of forces.

On the other hand, when the user installs the protective component (1) on the vehicle, the plate-shaped cover part (2000) may have sharp edges. To prevent accidents such as cuts or scratches caused by this, an anti-scratch component (2002) can be formed along the edges of the cover part (2000) to protect against such incidents.

The anti-scratch material (2002) is made of a material that is lightweight yet thick, possessing low rigidity and elastic recovery similar to polymer materials. Therefore, when users install the protective component (1) on a vehicle awning or awning rail (2), they can prevent damage caused by the cover part (2000).

The first cover (2100) is equipped on the outer side, and on the rear side, the second cover (2200) is inserted, forming a closely stacked and overlapping structure that allows sliding movement.

Thus, as shown in FIG. 6, the user can extend the overall length of the cover part (2000) by sliding the second cover (2200) from the first cover (2100) in the direction of the arrow at regular intervals to expose it to the outside, according to the shape of the front end of the vehicle awning or awning rail (2). This allows the cover part (2000) to provide a wider coverage range, ensuring safer protection for the vehicle awning.

In this case, on the inner side of the first cover (2100), specifically on the rear side of the curved surface (2001) formed on the first cover (2100), an inner rail (2110) is formed to allow the second cover (2200) to be easily inserted and coupled. This enables sliding movement of the second cover (2200) from the rear side of the first cover (2100).

Through the inner rail (2110), the second cover (2200) can slide along the inner side of the rear of the first cover (2100), enabling the length of the cover part (2000) to be extended or reduced.

The second cover (2200) is equipped on the rear side of the first cover (2100) in a combined state with the first cover (2100). Then, the second cover (2200) is coupled and fixed to the fixed frame (1200), so when the first cover (2100) is coupled to the second cover (2200), they can be supported through the fixed frame (1200).

The second cover (2200) is capable of sliding movement along the recessed surface on the rear side of the first cover (2100). Similar to the first cover (2100), the second cover (2200) also has curved surfaces (2001) formed along its edges, and anti-scratch component (2002) is formed along the edges of the second cover (2200).

In this case, the inner side of the first cover (2100) is made with the same shape and size as the outer side of the second cover (2200), so when the second cover (2200) slides inward through the inner rail (2110) of the first cover (2100), the second cover (2200) can be easily secured in a closely attached state to the rear side of the first cover (2100).

As a result, the second cover (2200) can be slid away from the first cover (2100) according to the user's intention, allowing the overall length of the cover part (2000) to be extended or shortened. In this case, when the first cover (2100) and the second cover (2200) are extended to the desired width and installed, a horizontal slide slit (2300) is formed that extends along the curved surface (2001) to secure the second cover (2200) onto the first cover (2100). Through the cover fixation component (2310) that penetrates the first and second covers (2100, 2200) in the front and rear direction around the horizontal slide slit (2300), the first and second covers (2100, 2200) can be securely fixed in the desired configuration.

First, the cover fixation component (2310) penetrating the first cover (2100) takes on a bolt-like shape and can move along the interior of the horizontal slide slit (2300) formed in the second cover (2200), allowing the second cover (2200) to slide toward the rear side of the first cover (2100). Afterwards, in cases where the cover part (2000) is expanded or reduced according to the desired form, nuts or similar components can be attached to secure the cover fixation component (2310), allowing the combination and fixation of the first and second covers (2100, 2200) through the cover fixation component (2310).

Therefore, users can extend or reduce the horizontal length of the cover part (2000) through the horizontal slide slit (2300) and the cover fixation component (2310).

The second cover (2200) is coupled with the fixed frame (1200) on the rear side, and the second cover (2200) is provided with a vertical slide slit (2400) which is perforated. Inside the vertical slide slit (2400), a frame fixation component (2410) with a bolt-like shape can be inserted and coupled.

The vertical slide slit (2400) extends vertically between the horizontal slide slits, and multiple pairs of vertical slide slits can be arranged to allow the cover part (2000) to slide vertically relative to the frame part (1000).

When coupling the protective component (1) to the awning rail (2) due to the relatively low installation location of the awning rail (2), the vertical slide slits (2400) allow for adjusting the position of the cover part (2000) relative to the frame part (1000) to be higher, thereby preventing contact between the vehicle (3) and the protective component (1).

These vertical slide slits (2400) are selectively positioned in the fastening component through hole (1230) and are coupled through the frame fixation component (2410). As a result, the frame part (1000) can be assembled and installed facing one side or the other side with the cover part (2000) as the center, allowing installation on both sides around the front of the vehicle.

Therefore, users can assemble protective components (1) of the same shape in desired forms to protect both the front and left sides as well as the front and right sides of the vehicle, allowing the installation of pairs to protect the vehicle awning.

The extended length, horizontal width, and thickness of the first cover (2100) and second cover (2200) are as follows.

The extension length of the first cover (2100) is designed and manufactured within the range of 17 to 27 cm, while the extension length of the second cover (2200) is ideally designed and manufactured within the range of 24 to 36 cm. In this case, as stated above, the extension length of the second cover (2200) must be longer than that of the first cover (2100).

Furthermore, the horizontal width of the first cover (2100) is 18 to 22 cm, and the horizontal width of the second cover (2200), which slides in a close-contact state along the rear inner side of the first cover (2100), is designed and manufactured within the range of 14.5 to 22.5 cm. In this case, the horizontal width of the first cover (2100) is intentionally designed to be larger than that of the second cover (2200), allowing the front end of the second cover (2200) to be enveloped by the first cover (2100) and enabling sliding movement. This design allows for adjusting the extension length of the cover part (2000).

Furthermore, the first cover (2100) and the second cover (2200) have the same thickness, preferably around 1 to 2 cm. However, this is not limited to this range.

The cover part (2000) is preferably installed with an angle of 28 to 44 degrees relative to the front of the awning rail (2) and the coupling frame (1100). The curved surfaces formed on the first cover (2100) and the second cover (2200) have an internal angle of 45 to 65 degrees, with a slope bent towards the front. Therefore, through the curved surface (2001), the cover part (2000) gradually reduces its frontal area towards the front so when encountering external objects like branches, they can easily pass outward along the cover part (2000) through the curved surface (2001). Additionally, during driving, the impact of aerodynamic pressure on the cover part (2000) can also be minimized.

The coupling fastening components (1111) for assembling the protective component (1), including the through bolt (1120), coupling frame fixing bolt (1312), the swivel bolt (1320), cover fixation components (2310), and frame fixation components (2410), are all made of materials that possess corrosion resistance, water resistance, and rigidity in order to prevent oxidation and scratches from collisions with external objects during driving. In this case, the materials of bolts, nuts, etc., can be stainless steel, but it is not intended to be limited to this.

Most preferable embodiments are disclosed in the drawings and specifications. Herein, specific terms have been used, but they have been used merely for the purpose of describing the present disclosure and are not intended to limit the scope of the present disclosure as defined in the claims or to restrict the scope of the present disclosure as described in the patent claims. Thus, those of ordinary skill in the art will understand that various modifications and equivalent other embodiments are possible therefrom. Therefore, the true technical protection scope of the present disclosure should be determined by the technical idea of the appended claims.

What is claimed is:

1. An awning-coupled protection component for vehicles coupled to a vehicle awning to protect an awning from an external force, the awning-coupled protection component comprising:
a frame part coupled to a vehicle awning; and
a cover part coupled to the frame part to protect the vehicle awning,
wherein the frame part includes:
a coupling frame coupled to the vehicle awning and extending in one direction;
a support frame supporting the coupling frame and the cover part; and
a fixed frame installed the rear side of the cover part to couple the coupling frame and the support frame to the cover part,
wherein the cover part is configured to have a predetermined angle with respect to the direction in which the coupling frame extends and to be inclined with respect to the coupling frame.

2. The awning-coupled protection component for vehicles according to claim 1, wherein
one end of the coupling frame is connected to the fixed frame, while the other end is designed to be connected to the vehicle awning rail and has a rail coupling part with an awning insertion groove, and the awning insertion groove of the rail coupling part extends in the same direction as the direction in which the coupling frame extends.

3. The awning-coupled protection component for vehicles according to claim 1, wherein
the pre-determined angle is defined as an acute angle formed between the coupling frame and the cover part.

4. The awning-coupled protection component for vehicles according to claim 1, wherein
the cover part is formed with the first cover and the second cover which have the same shape, while the second cover is coupled in a stacked manner in the front-to-back direction on the rear side of the first cover, and
the first cover slides along the second cover to extend the horizontal length of the cover part.

5. The awning-coupled protection component for vehicles according to claim 4, wherein
a horizontal slide slit extending along the sliding direction is formed at the upper and lower ends of the second cover,
the first cover includes a through hole passing through the first cover and a cover fixation component passing through the through hole, and
the cover fixation component moves along the horizontal slide slit to secure the first cover to the second cover.

6. The awning-coupled protection component for vehicles according to claim 4, wherein
the second cover further includes a plurality of vertical slide slits extending perpendicularly between the horizontal slide slits.

7. The awning-coupled protection component for vehicles according to claim 6, further comprising
a frame fixation component penetrating the cover part and the fixed frame that is movable along the plurality of vertical slide slits so that the position of the cover part relative to the frame part can be adjusted.

8. The awning-coupled protection component for vehicles according to claim 1, wherein
the frame part is configured with a first material, and the cover part is configured with a second material that is different from the first material, and wherein the first material has higher rigidity compared to the second material, while the second material is lighter than the first material.
